(19) United States
(12) Patent Application Publication
(10) Pub. No.: US 2013/0152775 A1
(43) Pub. Date: Jun. 20, 2013

(54) BLAST MITIGATION SEAT FOR A LAND VEHICLE

(71) Applicants: Chris P P. Jessup, Sheridan, IN (US); Douglas Wayne Bittner, Indianapolis, IN (US)

(72) Inventors: Chris P P. Jessup, Sheridan, IN (US); Douglas Wayne Bittner, Indianapolis, IN (US)

(73) Assignee: INDIANA MILLS & MANUFACTURING, INC., Westfield, US (US)

(21) Appl. No.: 13/640,418

(22) PCT Filed: Apr. 12, 2011
(86) PCT No.: PCT/US11/32105

§ 371 Date: Jan. 18, 2013

Related U.S. Application Data
(60) Provisional application No. 61/323,671, filed on Apr. 13, 2010.

(51) Int. Cl. B60N 2/42

(52) U.S. Cl. CPC B60N 2/42
USPC 89/36.08

(57) ABSTRACT

A blast mitigation seat for a land vehicle may include an occupant seat, at least one retraction device mounted to the seat, a first set of webs connected between the seat and a ceiling and/or a wall of the land vehicle, a second set of webs connected between the at least one retraction device and the ceiling and/or the wall of the land vehicle, and a third set of webs connected between the seat and the vehicle floor. The seat is suspended in the land vehicle by the first and third sets of webs. The first set of webs absorbs energy resulting from detonation of an explosive device beneath the floor of the land vehicle that forces the land vehicle from the ground into the air, and the second set of webs absorbs energy resulting from subsequent impact of the land vehicle with the ground.

### CROSS-REFERENCE TO RELATED U.S. APPLICATION

This patent application claims priority to, and the benefit of, U.S. Provisional Patent Application Ser. No. 61/323,671, filed Apr. 13, 2010 and entitled BLAST MITIGATION SEAT FOR A LAND VEHICLE, the disclosure of which is incorporated herein by reference in its entirety.

### FIELD OF THE INVENTION

The present invention relates generally to seats for mitigating forces resulting from detonation of explosive devices, and more specifically to such seats for use in land vehicles.

### BACKGROUND

Explosive devices are known that are designed to damage land vehicles when detonated beneath such vehicles. Typically, the detonation of such devices displaces the land vehicle upwardly into the air, and vacuum created beneath the land vehicle by the explosion then forces the vehicle back to the ground at a high rate of speed. The forces experienced during such subsequent high-speed contact with the ground may be substantial. It is therefore desirable to design seats carried by such land vehicles that mitigate forces resulting from not only the initial blast of the explosive device but also from subsequent impact between the vehicle and the ground.

### SUMMARY

The present invention may comprise one or more of the features recited in the claims appended hereto, and/or one or more of the following features and combinations thereof. A blast mitigation seat for a land vehicle may comprise an occupant seat, at least one retraction device mounted to the occupant seat, a first set of webs connected between the occupant seat and at least one of a ceiling and a wall of the land vehicle, a second set of webs connected between the at least one retraction device and the at least one of the ceiling and the wall of the land vehicle, and a third set of webs connected between the occupant seat and a floor of the land vehicle. The occupant seat may be suspended in the land vehicle by the first and third sets of webs. The first set of webs may be configured to absorb energy resulting from detonation of an explosive device beneath the floor of the land vehicle that forces the land vehicle from the ground into the air. The second set of webs may be configured to absorb energy resulting from subsequent impact of the land vehicle with the ground.

The occupant seat may comprise a seat bottom and a seat back extending upwardly from the seat bottom. The at least one retraction device may form part of the seat back. The third set of webs may be connected between the seat bottom and the floor of the land vehicle.

The first set of webs may be configured to absorb the energy resulting from detonation of the explosive device by elongating as the occupant seat moves toward the vehicle floor while the vehicle is forced from the ground into the air. The at least one retraction device may be configured to remove slack from the second set of webs as the occupant seat moves upwardly while the vehicle is drawn back toward the ground following detonation of the explosive device. The second set of webs may be configured to absorb the energy resulting from subsequent impact of the vehicle with the ground by elongating as the occupant seat moves toward the vehicle floor when the vehicle impacts the ground.

The at least one retraction device may comprise at least one linear retractor. Alternatively or additionally, the at least one retraction device may comprise at least one rotary retractor.

In one embodiment, the blast mitigation seat may further comprise a fourth set of webs connected between the occupant seat and at least one of the ceiling and the wall of the land vehicle, the occupant seat may comprise a seat back connected to a seat bottom, the first set of webs may be connected between the at least one of the ceiling and the wall and the seat back at or near one side thereof, and the fourth set of webs may be connected between the at least one of the ceiling and the wall and the seatback at or near an opposite side thereof. The at least one retraction device may comprise a first retraction device forming part of or attached to the seat back at or near the one side thereof and a second retraction device forming part of or attached to the seat back at or near the opposite side thereof. The second set of webs may be connected between the first retraction device and the at least one of the ceiling and the wall of the land vehicle, and the blast mitigation seat may further comprise a fifth set of webs connected between the second retraction device and at least one of the ceiling and the floor of the land vehicle. The third set of webs may be connected between the seat bottom and the floor of the land vehicle.

In another embodiment, the occupant seat may comprise a seat back connected to a seat bottom, the at least one retraction device may comprise a first retraction device forming part of or attached to the seat back at or near one side thereof and a second retraction device forming part of or attached to the seat back at or near an opposite side thereof, the second set of webs may be connected between the first retraction device and the at lest one of the ceiling and the wall of the land vehicle, and the blast mitigation seat may further comprise a fourth set of webs connected between the second retraction device and at least one of the ceiling and the floor of the land vehicle. The third set of webs may be connected between the seat bottom and the floor of the land vehicle. The first and second retraction devices may each comprise linear retractors. Alternatively or additionally, the first and second retraction devices may each comprise rotary retractors.

A method may be provided for absorbing energy in an occupant seat suspended within a land vehicle during an entire blast event. In the entire blast event, the land vehicle may be forced from the ground into the air by a primary blast event resulting form detonation of an explosive device beneath the land vehicle, and the detonation of the explosive device may also create a vacuum under the land vehicle that forces the land vehicle back toward the ground following the primary blast event. The method may comprise absorbing energy during the primary blast event with a first set of webs connected between the occupant seat and at least one of a ceiling and a wall of the land vehicle, and absorbing energy during impact of the land vehicle with the ground following the primary blast event with a second set of webs connected between the occupant seat and at least one of a ceiling and a wall of the land vehicle.

### BRIEF DESCRIPTION OF THE DRAWINGS

FIG. 1 is a front view of one illustrative embodiment of a blast mitigation seat for a land vehicle.

FIG. 2 is a front perspective view of the blast mitigation seat.

FIG. 3 is a magnified rear perspective view of a portion of the blast mitigation seat.

FIG. 4 is a magnified front perspective view of a bottom portion of the blast mitigation seat.

FIG. 5 is a front perspective view of the blast mitigation seat with the cover removed.

FIG. 6 is a rear perspective view of the blast mitigation seat with the cover removed.

FIG. 7 is a graphical representation of a side view of the blast mitigation seat during normal travel of the land vehicle in which the seat is mounted.

FIG. 8 is a view similar to FIG. 7 illustrating displacement of, and damage to, the vehicle carrying the blast mitigation seat resulting from detonation of an explosive device beneath the vehicle, and further illustrating reaction of the blast mitigation seat in response to the blast.

FIG. 9 is a view similar to those of FIGS. 7-8 illustrating the reaction of the blast mitigation seat as the vehicle reaches its apogee resulting from the blast.

FIG. 10 is a view similar to those of FIGS. 7-9 illustrating the reaction of the blast mitigation seat as the vehicle moves downwardly to the ground after the blast.

FIG. 11 is a view similar to those of FIGS. 7-10 illustrating the reaction of the blast mitigation seat when the vehicle impacts the ground following the blast.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

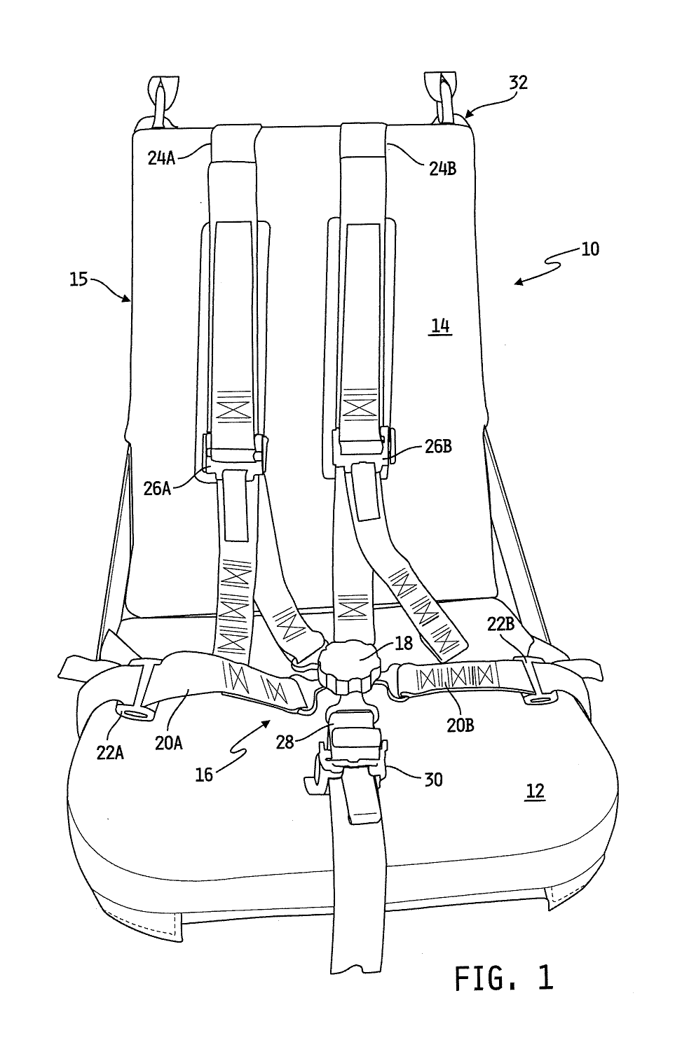

Referring now to FIG. 1, one illustrative embodiment of a blast mitigation seat 10 for use in a land vehicle is shown. In the illustrated embodiment, the seat 10 includes a seat bottom 12 and a seat back 14 extending upwardly away from the seat bottom 12. A cover 15 surrounds the underlying structure of the vehicle seat 10, although it will be understood that the cover 15 is not required for the functionality of the seat 10. In any case, a conventional restraint system 16 is mounted to the seat 10, and is configured in a conventional manner to restrain an occupant of the seat 10.

In the illustrated embodiment, the restraint system 16 is a conventional 5-point restraint system that includes a central engagement member 18 configured to releasably engage corresponding engagement members of a pair of lap webs 20A, 20B, a pair of shoulder webs 24A, 24B and a crotch strap or web 28, each having a free end attached to the seat 10. Illustratively, each of the lap webs 20A, 20B include a corresponding, conventional web length adjustment device 22A, 22B respectively, each of the shoulder webs 24A, 24B include a corresponding, conventional web length adjustment device 26A, 26B respectively, and the crotch strap or web 28 includes a conventional web length adjustment device 30. It will be understood that while the blast mitigation seat 10 is illustrated in the figures as having a 5-point restraint system mounted thereto, the restraint system may generally be any conventional m-point restraint system, where m may be any integer greater than 1 such that the m-point restraint system is any conventional multiple-point restraint system.

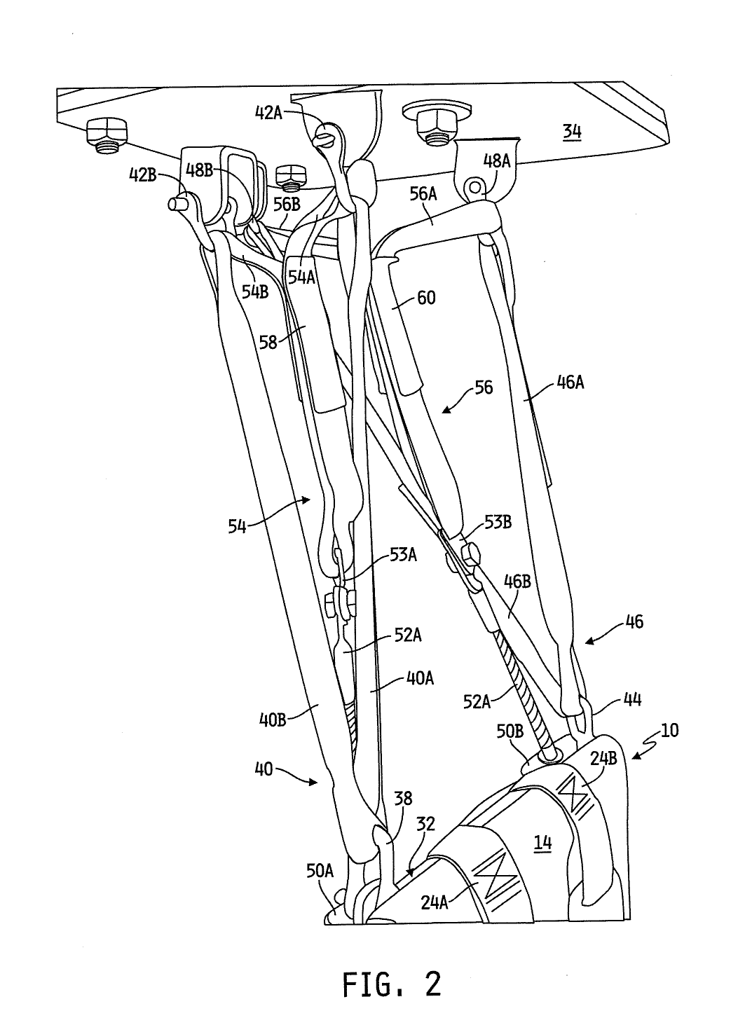

The blast mitigation seat 10 is, in the illustrated embodiment, configured to be suspended within the hull of a land vehicle. In this regard, the blast mitigation seat 10 includes a number of webs, straps or tethers each configured to be attached at one end to the seat 10 and to the hull of the vehicle carrying the seat 10 at the opposite end. For example, referring to FIGS. 1 and 2, the blast mitigation seat 10 is mounted to the ceiling 34 of a land vehicle 36 via two separate sets of webs. A first of the two web sets includes web pairs 40 and 46. The web pair 40 includes a pair of webs 40A and 40B each connected at one end to a web attachment member 38 of a seat mounting bracket 32 that forms part of, or is attached to, the blast mitigation seat 10. The opposite end of the web 40A is attached to a front web attachment member 42A that is mounted to the ceiling 34 of the vehicle 36, and the opposite end of the web 40B is attached to a rear web attachment member 42B that is mounted to the ceiling 34 rearwardly of the front web attachment member 42A. The web pair 46 includes a pair of webs 46A and 46B each connected at one end to another web attachment member 44 that forms part of, or is attached to, the seat mounting bracket 32, wherein the web attachment members 38 and 44 are positioned at or near opposite sides of the top portion of the seat back 14. The opposite end of the web 46A is attached to another front web attachment member 48A that is mounted to the ceiling 34 of the vehicle 36 and spaced apart from the front web attachment member 42A, and the opposite end of the web 46B is attached to another rear web attachment member 48B that is mounted to the ceiling 34 rearwardly of the front web attachment member 48A and adjacent to the rear web attachment member 42B.

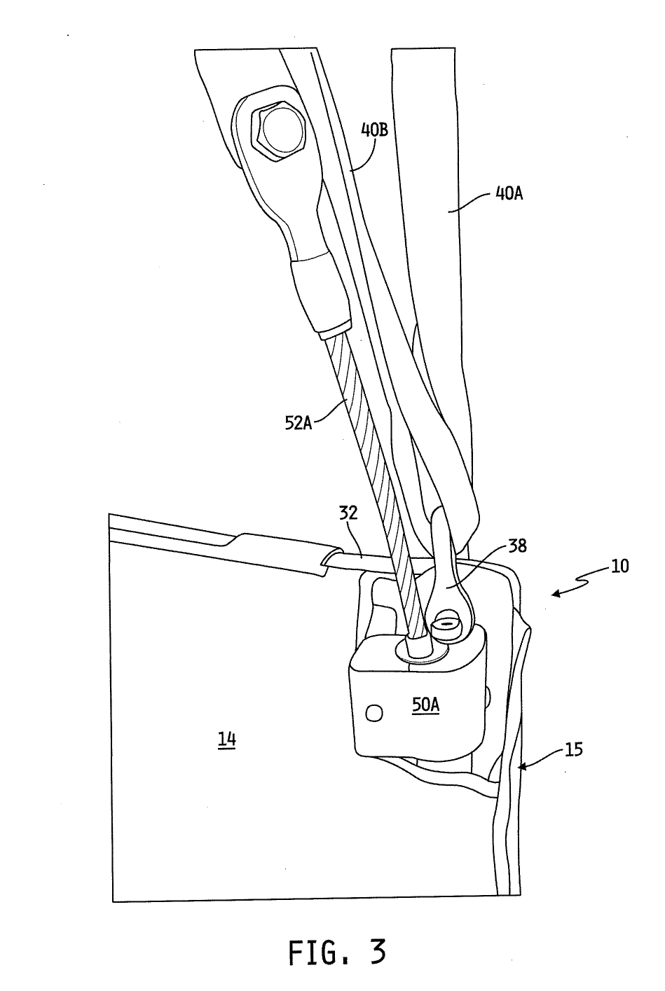

A second of the two web sets includes webs 54 and 56. Illustratively, the web 54 is implemented as a single web looped through a web engagement member 53A that is attached to one end of a cable 52A such that the web 54 forms two web portions 54A and 54B. The free end of the web portion 54A is attached to the front web attachment member 42A, and the free end of the web portion 54B is attached to the rear web attachment member 42B. The opposite end of the cable 52A is attached to a retraction device 50A that forms part of, or is attached to, the blast mitigation seat 10. As seen most clearly in FIG. 3, the retraction device 50A is illustratively provided in the form of a linear retraction device which is mounted to the seat mounting bracket 32 adjacent to the web attachment member 38. In any case, the web portions 54A and 54B are joined together between the web engagement member 53A and the web attachment members 42A, 42B by a tear-away member 58. Illustratively, the tear-away member 58 is designed to tear away from the web set 54 when sufficient downward force is applied to the cable 52A so that the web portions 54A and 54B separate from each other. In one embodiment, the tear-away member 58 is provided in the form of a fabric sheet or length of fabric that is wrapped around or otherwise joins the web portions 54A, 54B, although this disclosure contemplates that the tear-away member 58 may be provided in other conventional forms.

The web 56 is also illustratively implemented as a single web looped through a web engagement member 53B that is attached to one end of a cable 52B such that the web forms two web portions 56A and 56B. The free end of the web portion 56A is attached to the front web attachment member 48A, and the free end of the web portion 56B is attached to the rear web attachment member 48B. The opposite end of the cable 52B is attached to another retraction device 50B that forms part of, or is attached to, the blast mitigation seat 10. Illustratively, the retraction device 50B is provided in the form of a linear retraction device, which is illustratively identical to the retraction device 50A, and which is mounted to the seat mounting bracket 32 adjacent to the web attachment member 44. As with the web portions 54A, 54B, the web portions 56A and 56B are joined together between the web engagement member 53B and the web attachment members 48A, 48B by a tear-away member 60, which is illustratively designed to tear away from the web set 56 when sufficient downward force is applied to the cable 52B so that the web portions 56A and 56B separate from each other. In one embodiment, the tear-away member 60 is provided in the form of a fabric sheet or length of fabric that is wrapped around or otherwise joins the web portions 56A, 56B, although this disclosure contemplates that the tear-away member 60 may be provided in other conventional forms. It will be understood that in alternative embodiments either or both of the webs 54 and 56 may be implemented as two separate webs.

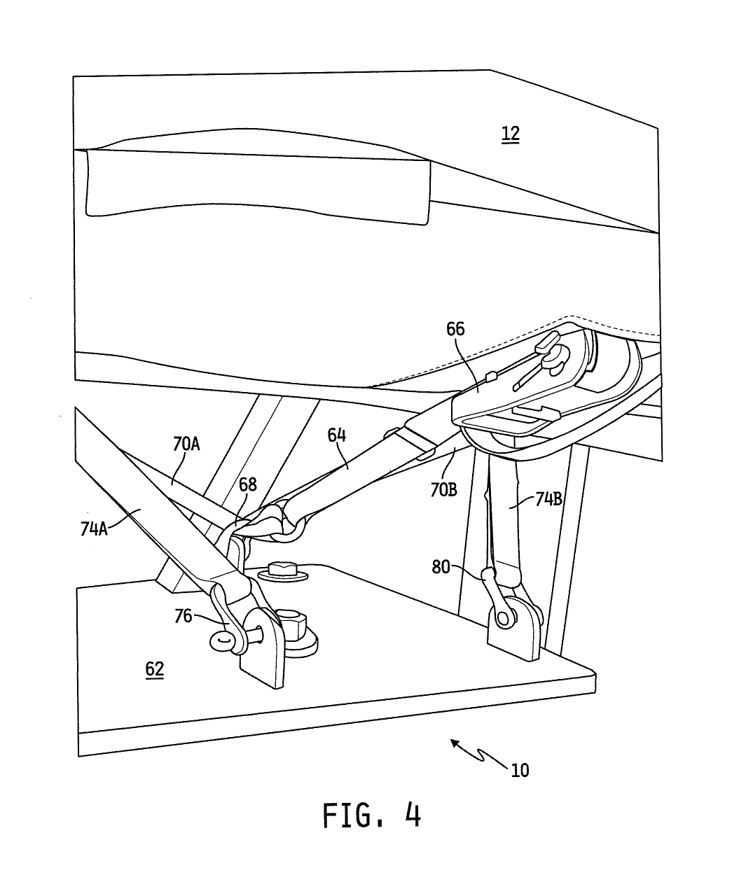

Referring now to FIG. 4, a magnified front perspective view of the blast mitigation seat 10 is shown. In the illustrated embodiment, a web 64 is mounted at one end to a conventional web length adjusting device 66 that is mounted to the seat bottom 12. The opposite end of the web 64 is attached to a pair of webs 70A and 70B that extend through a retaining member 68, e.g., a retaining ring, attached to a floor 62 of the vehicle. Opposite ends of the webs 70A and 70B are attached to opposing sides of the seat 10 at the rear of the seat 10. One end of a third web 74A is attached to one side of the seat bottom 12, and the opposite end web 74A is attached to a web attachment member 76, e.g., a retaining ring, that is mounted to the floor 62. One end of a fourth web 74B is attached to an opposite side of the seat bottom 12, and the opposite end of the web 74B is attached to another web attachment member 80, e.g., a retaining ring, that is also mounted to the floor 62. The webs 70A, 70B, 74A and 74B illustratively comprise a third web set. The seat 10 is suspended within the hull of the vehicle 36, e.g., between the floor 62 of the vehicle 36 and at least one of the ceiling 34 and a wall of the vehicle 36, via the first and third web sets, i.e., 40, 46 and 70A, 70B, 74A, 74B, and the second web set, i.e., webs 54 and 56, is connected between the retraction devices 50A and 50B respectively and at least one of the ceiling 34 and a wall of the vehicle 36.

The blast mitigation seat 10 is, in operation, mounted within the vehicle 36 such that that the seat 10 is suspended in the hull of the vehicle 36 between the ceiling 34 and the floor 62, or alternatively between the ceiling 34 and/or one or more of the walls and the floor 62 of the vehicle 36. To accomplish this in the illustrated embodiment, the various webs are attached and arranged as described hereinabove, and the web length adjusting device 66, e.g., a ratcheting or retracting device, is manipulated to draw the webs 70A and 70B through the retaining member 68 toward the device 66. This simultaneously causes the web pairs 40 and 46, as well as the webs 70A, 70B, 74A and 74B, to be drawn tight such that the seat 10 is anchored in suspension between the ceiling 34 and floor 62, and is stabilized against movement by an occupant thereof. The web set 40, 46, as well as the web pairs 70A, 70B and 74A, 74B are illustratively formed of high-strength fabric, and it is these webs that normally anchor and support the seat 10 during normal operation of the vehicle 36. Whereas the web set 40, 46, as well as the web pairs 70A, 70B and 74A, 74B, are normally taut as just described, the web set 54, 56 normally has some amount of slack such that these webs do not serve any function during normal operation of the vehicle 36. Rather, the web set 54, 56 is used only during a blast event as will be described in detail hereinafter.

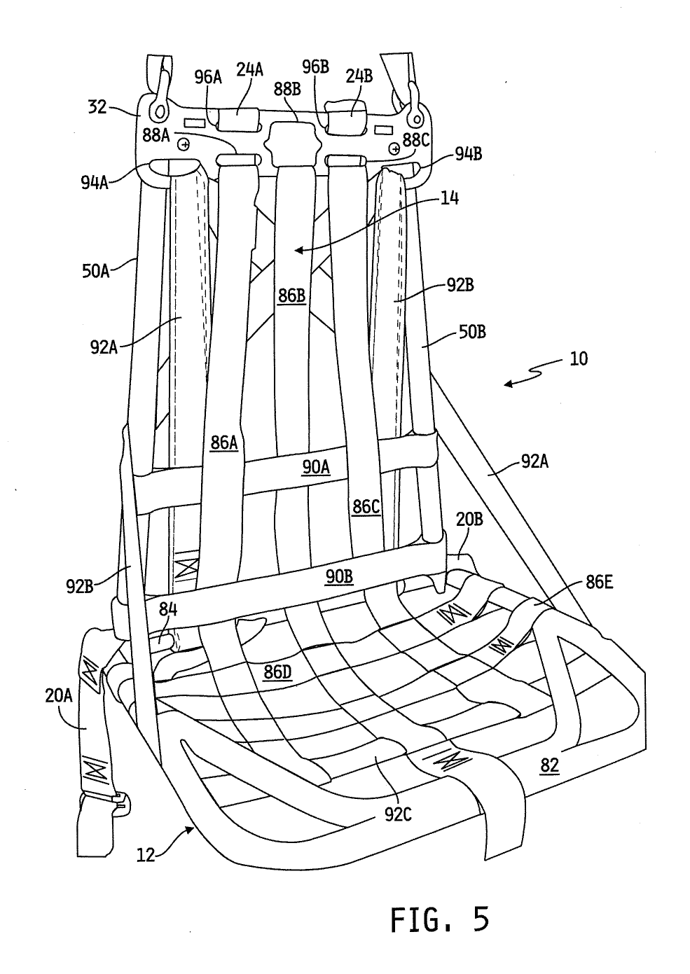

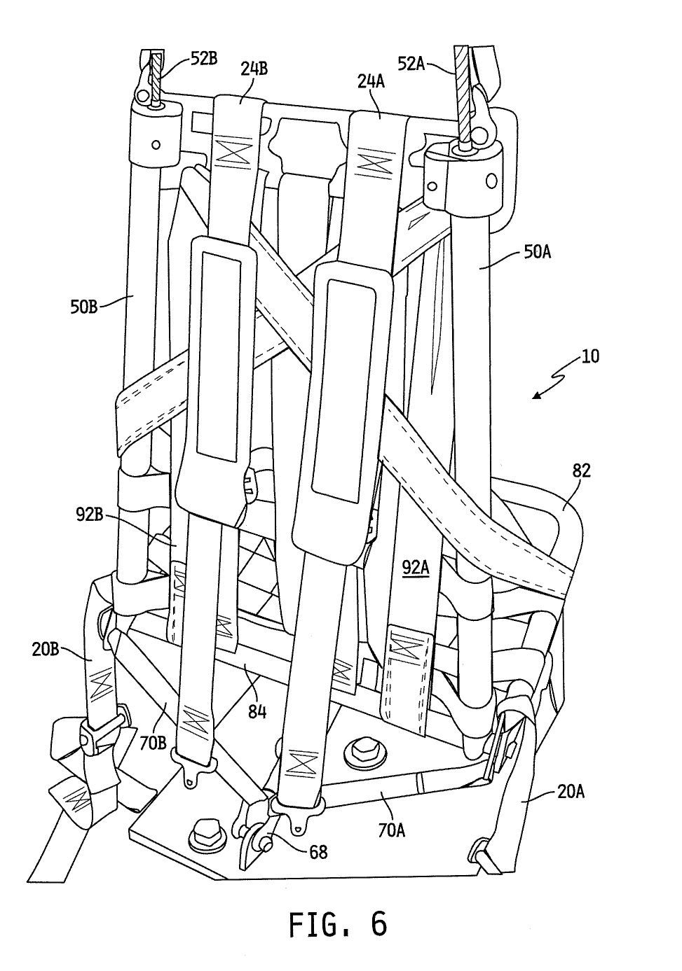

Referring now to FIGS. 5 and 6, front and rear perspectives are shown of the blast mitigation seat 10 with the cover 15 removed to illustrate one illustrative embodiment of the underlying structure of the seat 10. Illustratively, the seat bottom 12 is formed of a rigid tube structure 82 shaped in the form of a conventional seat bottom and mounted on either side of the seat to a rear frame member 84, which is also illustratively provided in the form of a rigid tube structure. In one embodiment, the tube structures 82 and 84 are formed of lightweight aluminum, although other materials are contemplated. The retraction devices 50A and 50B are illustratively connected between the rear frame member 84 and the seat mounting bracket 32 on either side of the seat 10. In the illustrated embodiment, the retraction devices 50A and 50B are provided in the form of conventional linear retractors, although this disclosure contemplates embodiments in which either or both of the retraction devices 50A and 50B are provided in the form of conventional rotary retractors.

In the illustrated embodiment, a trio of webs 86A, B and C extend from the seat mounting bracket 32 downwardly to define the seat back 14, and further extend forwardly from the bottom of the seat back 14 to define a portion of the seat bottom 12. One end of the web 86A is attached to the seat mounting bracket 32 via a web slot 88A, and ends of the webs 86B and 86C are likewise mounted to the seat mounting bracket 32 via web slots 88B and 88C respectively. A pair of webs 86D and 86E extends transversely across the seat bottom 12 and is connected at opposite ends to the tube structure 82. The webs 86D and 86E are interwoven through the webs 86A, B and C to form an occupant support surface of the seat bottom 12. Another transverse web 90A extends between, and is attached to, the retraction devices 50A and 50B between the seat mounting bracket 32 and the junction of the seat back 14 with the seat bottom 12, and yet another transverse web 90B extends between, and is attached to, the retraction devices 50A and 50B at or near the junction of the seat back 14 with the seat bottom 12. Together the webs 86A-E, along with the webs 90A and 90B, form the occupant support structure of the seat 10.

The seat 10 further includes a pair of load bearing straps or webs 92A and 92B each having one end attached to the rear frame member 84 near opposite ends of the seat 10. The opposite end of the web 92A extends upwardly from the rear frame member 84, through a web slot 94A defined through the seat mounting bracket 32, across the back 14 of the seat 10, around the retraction device 50B and into attachment with the tube structure 82 near a front of the seat bottom 12. The opposite end of the web 94B likewise extends upwardly from the rear frame member 84, through a web slot 94B defined through the seat mounting bracket 32, across the back 14 of the seat 10, around the retraction device 50A and into attachment with the tube structure 82 near a front of the seat bottom 12. A third load bearing strap 92C extends transversely between, and is attached to, the tube structure 82 near the front of the seat bottom 12. Alternatively, the first, second and third load bearing straps 92A, 92B and 92C may be a single web or strap. In any case, the load bearing straps 92A-92C act to maintain the shape of the seat 10 as illustrated in the drawings.

It should further be evident from FIGS. 5 and 6 that the shoulder webs 24A and 24B extend through slots 96A and 96B respectively defined through the seat mounting bracket 32, and corresponding ends of the shoulder webs 24A and 24B are attached to the bracket 32 via these slots 96A and 96B. Ends of the lap webs 24A and 24B are attached to the rear frame member 84, as are the ends of the webs 70A and 70B.

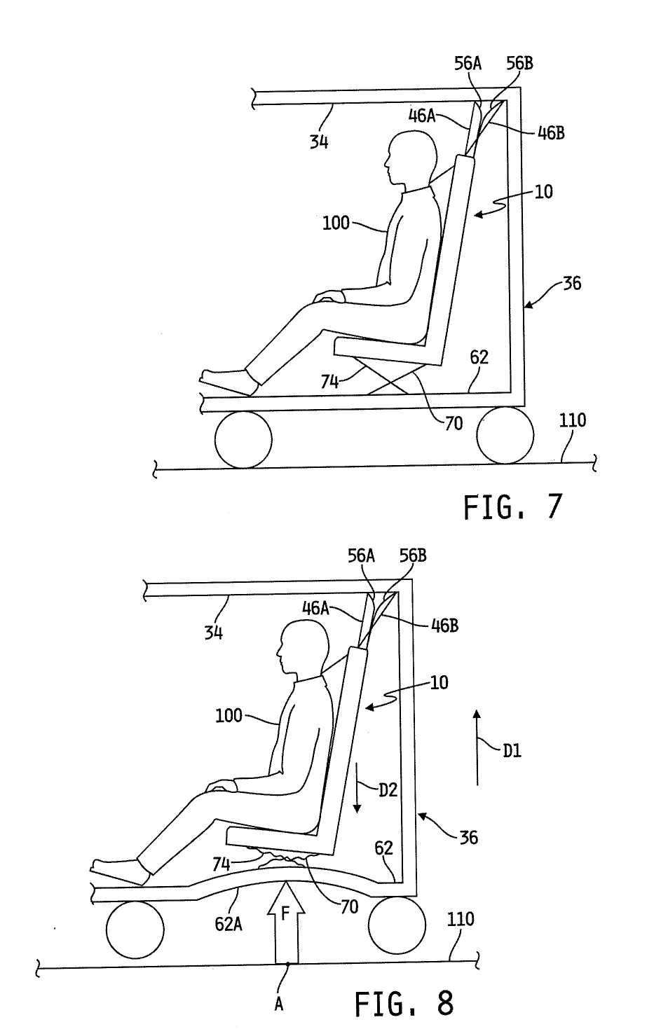

Referring now to FIGS. 7-11, a series of graphical representations is shown depicting the reaction of the blast mitigating seat 10 to the detonation of an explosive device under the land vehicle 36 carrying the seat 10. The blast associated with the detonation of the explosive device is sufficiently large to drive the vehicle 36 airborne and to also create a vacuum under the vehicle 36 that subsequently draws the vehicle 36 back to the ground with a force greater than gravity acting upon the land vehicle 36. As described hereinabove, the seat 10 is suspended within the hull of the vehicle 10, e.g., between the ceiling 34 and the floor 62. Although the web set 40, 46 normally suspends the seat 10 from the ceiling 34 (or from at least one of the ceiling 34 and a wall of the vehicle 36) as described hereinabove, only one of the web pairs 46 is illustrated in FIGS. 7-11 since the seat 10 and vehicle 36 are illustrated in side view. Thus, only the webs 46A and 46B are illustrated in FIGS. 7-11. Likewise, although the ancillary web set 54, 56 is also connected between the top portion of the seat 10 and the vehicle ceiling 34 (or at least one of the ceiling 34 and a wall of the vehicle 36) as described hereinabove, only one of the webs 56 is illustrated in FIGS. 7-10. Thus, only the web portions 56A and 56B are illustrated in FIGS. 7-11. Similarly, although the third web set 70A, 70B and 74A, 74B normally anchors the seat 10 to the vehicle floor 62, only two webs of this set are shown. Thus, only the anchor webs 70B and 74B are shown in FIGS. 7-11. Details of the restraint system 16 are omitted from FIGS. 7-10 for ease of illustration, it being understood that the restraint system 16 will typically be included with the blast mitigation seat 10.

Referring now specifically to FIG. 7, the blast mitigation seat 10 and vehicle 36 are depicted during normal travel of the land vehicle 36 in which the seat 10 is mounted. An occupant 100 is shown occupying the seat 10, and the vehicle 36 is depicted as traveling on land 110. During normal travel of the vehicle 36, as described hereinabove, the webs 46A, 46B, 70B and 74B will be taut, whereas the webs 56A and 56B will be bound together and both include some amount of slack as illustrated in FIG. 7. Referring to FIG. 8, an explosive device has just detonated at the point A. The blast resulting from this detonation directs an upward force, F, against the floor 62 of the vehicle causing at least a portion of the floor 62 to deform inwardly (upwardly in FIG. 8), and further causing the vehicle 36 to be displaced upwardly in the direction D₁. Illustratively, part of the deformation in the floor 62 resulting from the blast is elastic and part is inelastic, resulting in some amount of permanent upward deformation in the floor 62. This upward displacement of the floor 62 causes the floor anchors for the webs 70 and 74 to be also upwardly displaced, thereby introducing slack into the webs 70 and 74 as illustrated in FIG. 8. As the vehicle 36 begins to rise in the air under the force, F, of the blast, the occupied seat 10 begins to move downwardly in a direction D₂ toward the floor 62.

As the vehicle continues to move upwardly under the force, F, of the blast, the occupied seat 10 continues to move downwardly, and the force of this downward movement causes the upper webs 46A and 46B to elongate as they absorb energy from the blast. As the seat 10 moves downwardly while the upper webs 46A and 46B elongate, slack is taken from the webs 56A and 56B. At some point during this downward movement of the seat 10, the tear-away member 60 is torn away by the separating webs 56A and 56B, and the webs 56A and 56B become taut. FIG. 9 illustrates the end of the primary blast event during which the vehicle 36 has been forced upwardly into the air in the direction D₁, and the seat 10 has traveled downwardly in the direction D₂ toward the floor 62 while the webs 46A, 46B have elongated and the webs 56A, 56B have separated from each other and become taut. During this primary blast event, the webs 56A and 56B have experienced only activation loads which are illustratively on the order of 100 lbs. As these activation loads have been applied by the webs 56A and 56B to the retraction devices 50A and 50B, the retraction devices 50A and 50B attempt to stroke. However, as long as the seat 10 is moving downwardly under the force, F, of the blast, the retractions devices 50A and 50b cannot stroke. In FIG. 9, the vehicle 36 has reached its apogee from the blast, and for a brief period of time the system is weightless. When this occurs, the retraction devices 50A and 50B stroke and attempt to tighten the webs 56A and 56B by drawing the webs 56A and 56B toward the seat bottom 12.

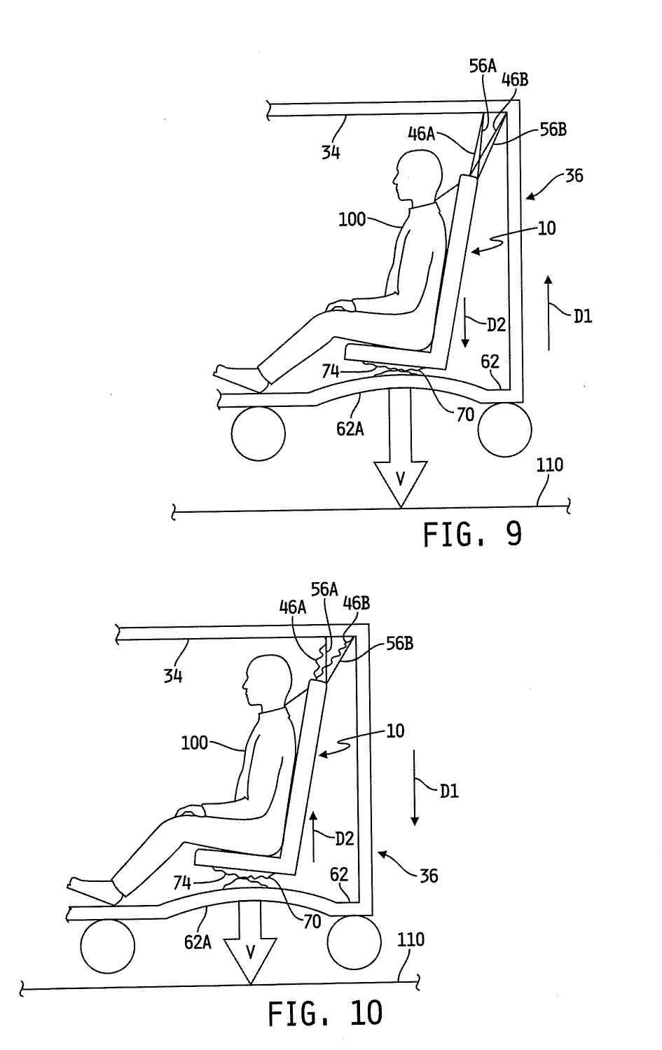

The blast created by detonation of the explosive device displaces atmosphere under the floor 62 of the vehicle 36 and creates a vacuum that draws the vehicle 36 back to the ground with a vacuum force, V, that is greater, e.g., up to 3 times greater, than the gravitational force, g, acting on the vehicle 36. This is depicted in FIGS. 9 and 10. After reaching its apogee, as depicted in FIG. 9, the vehicle 36 is accelerated by the force V (and also g) toward the ground 110 and the direction D₁ of the vehicle thus reverses to a downward direction as illustrated in FIG. 10. This action causes the direction D2 of the seat 10 and occupant 100 to likewise reverse to an upward direction as also illustrated in FIG. 10. As the seat 10 and occupant 100 move upwardly while the vehicle 36 is being forcibly drawn to the ground 110, the retraction devices 50A and 50B remove slack from the webs 56A and 56B and thereby tighten the webs 56A and 56B and maintain the webs 56A and 56B taut relative to the seat 10 as illustrated in FIG. 10. Because the webs 46A and 46B were elongated during the primary blast event, slack is introduced into these webs 46A and 46B as the seat 10 travels upwardly as also illustrated in FIG. 10.

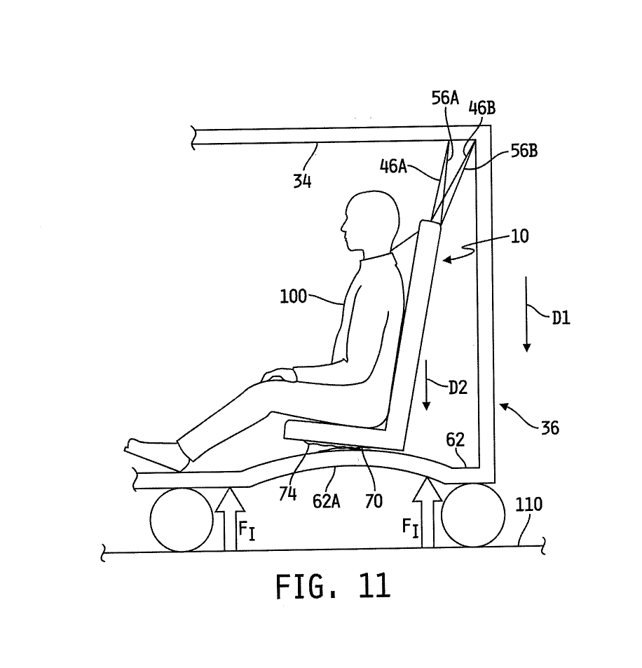

FIG. 11 illustrates the impact of the vehicle 36 with the ground 110 following the blast event, during which the vehicle impacts the ground 100 with an impact force F₁ resulting from the vacuum force, V, and the gravitational force, g, acting on the vehicle 36 during its descent to the ground 110. The impact force, F₁, acting upwardly on the vehicle 36 by the ground 110 causes the direction, D₂, of the seat 10 to again reverse so that the seat 10 travels downwardly under the impact force, F₁. As the seat 10 begins to travel downwardly during the impact event, load is transferred to the retraction devices 50A and 50B causing them to lock in a conventional manner. As the seat 10 continues to travel downwardly during this impact event, the webs 56A and 56B elongate as they absorb energy from the impact event as illustrated in FIG. 11. At the end of the entire blast event, both web sets 46 and 56 have become elongated from absorbing energy; the web set 46 from the initial blast event and the web set 56 from the impact of the vehicle 36 with the ground 110 following the initial blast event. Illustratively, the webs sets 40, 46, 54 and 56, as well as the retraction devices 50A and 50B, are sized and configured to keep the seat bottom 12 from contacting the floor 62 of the vehicle 36 throughout the entire blast event.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. For example, while the blast mitigation seat 10 has been illustrated and described herein as including two sets of webs that each absorb energy during different parts of a blast event, this disclosure contemplates alternatively using only a single set of webs that absorb energy during the primary blast event and also during impact of the vehicle with the ground following the primary blast event. Such embodiments may include, for example, one or more sets of retractors that tighten the single set of webs after they have elongated while dissipating energy during the primary blast event but prior to impact of the vehicle with the ground following the primary blast event. Such a single set of webs must be capable, in such embodiments, of elongating and absorbing energy during two back-to-back energy producing events; the primary blast followed by impact of the vehicle with the ground. As another example, either embodiment may include only a single retraction device that is configured to tighten one or more webs after the primary blast event and prior to the vehicle impact event.

What is claimed is:

1. A blast mitigation seat for a land vehicle, comprising:
an occupant seat,
at least one retraction device mounted to the occupant seat,
a first set of webs connected between the occupant seat and at least one of a ceiling and a wall of the land vehicle,
a second set of webs connected between the at least one retraction device and at least one of the ceiling and the wall of the land vehicle and
a third set of webs connected between the occupant seat and a floor of the land vehicle,
wherein the occupant seat is suspended in the land vehicle by the first and third sets of webs, the first set of webs configured to absorb energy resulting from detonation of an explosive device beneath the floor of the land vehicle that forces the vehicle from the ground into the air, the second set of webs configured to absorb energy resulting from subsequent impact of the land vehicle with the ground.

2. The blast mitigation seat of claim 1 wherein the occupant seat comprises a seat bottom and a seat back extending upwardly from the seat bottom,
and wherein the at least one retraction device forms part or is attached to of the seat back.

3. The blast mitigation seat of claim 2 wherein the third set of webs is connected between the seat bottom and the floor of the land vehicle.

4. The blast mitigation seat of claim 1 wherein the first set of webs is configured to absorb the energy resulting from detonation of the explosive device by elongating as the occupant seat moves toward the vehicle floor while the vehicle is forced from the ground into the air.

5. The blast mitigation seat of claim 4 wherein the at least one retraction device is configured to remove slack from the second set of webs as the occupant seat moves upwardly while the vehicle is drawn back toward the ground following detonation of the explosive device.

6. The blast mitigation seat of claim 5 wherein the second set of webs is configured to absorb the energy resulting from subsequent impact of the vehicle with the ground by elongating as the occupant seat moves toward the vehicle floor when the vehicle impacts the ground.

7. The blast mitigation seat of claim 1 wherein the at least one retraction device comprises at least one linear retractor.

8. The blast mitigation seat of claim 1 wherein the at least one retraction device comprises at least one rotary retractor.

9. The blast mitigation seat of claim 1 further comprising a fourth set of webs connected between the occupant seat and at least one of the ceiling and the wall of the land vehicle,
wherein the occupant seat comprises a seat back connected to a seat bottom,
and wherein the first set of webs is connected between the at least one of the ceiling and the wall and the seat back at or near one side thereof,
and wherein the fourth set of webs is connected between the at least one of the ceiling and the wall and the seatback at or near an opposite side thereof.

10. The blast mitigation seat of claim 9 wherein the third set of webs is connected between the seat bottom and the floor of the land vehicle.

11. The blast mitigation seat of claim 9 wherein the at least one retraction device comprises a first retraction device forming part of or attached to the seat back at or near the one side thereof and a second retraction device forming part of or attached to the seat back at or near the opposite side thereof,
and wherein the second set of webs is connected between the first retraction device and the at least one of the ceiling and the wall of the land vehicle,
and wherein the blast mitigation seat further comprises a fifth set of webs connected between the second retraction device and at least one of the ceiling and the floor of the land vehicle.

12. The blast mitigation seat of claim 11 wherein the third set of webs is connected between the seat bottom and the floor of the land vehicle.

13. The blast mitigation seat of claim 1 wherein the occupant seat comprises a seat back connected to a seat bottom,
and wherein the at least one retraction device comprises a first retraction device forming part of or attached to the seat back at or near one side thereof and a second retraction device forming part of or attached to the seat back at or near an opposite side thereof,
and wherein the second set of webs is connected between the first retraction device and the at lest one of the ceiling and the wall of the land vehicle,
and wherein the blast mitigation seat further comprises a fourth set of webs connected between the second retraction device and at least one of the ceiling and the floor of the land vehicle.

14. The blast mitigation seat of claim 13 wherein the third set of webs is connected between the seat bottom and the floor of the land vehicle.

15. The blast mitigation seat of claim 13 wherein the first and second retraction devices each comprise linear retractors.

16. The blast mitigation seat of claim 13 wherein the first and second retraction devices each comprise rotary retractors.

17. A method of absorbing energy in an occupant seat suspended within a land vehicle during an entire blast event in which the land vehicle is forced from the ground into the air by a primary blast event resulting form detonation of an explosive device beneath the land vehicle and in which the detonation of the explosive device also creates a vacuum under the land vehicle that forces the land vehicle back toward the ground following the primary blast event, the method comprising:
absorbing energy during the primary blast event with at least one set of webs connected between the occupant seat and at least one of a ceiling and a wall of the land vehicle, and
absorbing energy during impact of the land vehicle with the ground following the primary blast event with at least another set of webs connected between the occupant seat and at least one of a ceiling and a wall of the land vehicle.
